(19) United States
(12) Patent Application Publication
(10) Pub. No.: US 2022/0377837 A1
(43) Pub. Date: Nov. 24, 2022

(54) MASTER AND SLAVE OF BLUETOOTH COMMUNICATION SYSTEM CAPABLE OF DISCONNECTING CONNECTION

(71) Applicant: AUDIOWISE TECHNOLOGY INC., Hsinchu County (TW)

(72) Inventor: Yu-Feng CHEN, Hsinchu County (TW)

(21) Appl. No.: 17/325,570

(22) Filed: May 20, 2021

(51) Int. Cl. H04W 76/30; H04W 76/14; H04W 68/00

(52) U.S. Cl. CPC H04W 76/30; H04W 76/14; H04W 68/00

(57) ABSTRACT

There is provided a Bluetooth communication system including a master device and a slave device. After a link is established by a paging procedure, the master device determines whether to stop the link according to a connection quality calculated by a controller thereof. Before replying an accepted message LMP_accepted to the master device, the slave device determines whether to reply the accepted message according to a connection quality calculated by a controller thereof.

### BACKGROUND

1. Field of the Disclosure

This disclosure generally relates to a Bluetooth communication system and, more particularly, to a master and a slave of a Bluetooth communication system capable of disconnecting a connection due to poor connection quality after a link between the master and the slave is established.

2. Description of the Related Art

Current Bluetooth standard does not provide any method to determine whether a connection should be accepted or not after a link has been established. In the Bluetooth reconnection or a device being connected, if the connection quality is not good, it is possible to cause the LMP response timeout, profile setup failure or authentication failure thereby causing the pairing data to be cleaned.

Accordingly, the present disclosure provides a master device and a slave device of a Bluetooth communication system that terminate or cutoff a link when the link quality is poor.

### SUMMARY

The present disclosure provides a Bluetooth communication system whose master device has a controller that actively or passively provides a connection quality parameter to a host of the master device after a link is established by a paging procedure such that the host determines whether to accept the connection according to the received connection quality parameter.

The present disclosure further provides a Bluetooth communication system whose slave device determines whether to reply an accepted message LMP_accepted according to the connection quality parameter before replying the accepted message.

The present disclosure provides a master device configured to establish a link with a slave device in a paging procedure of Bluetooth connection. The master device includes a controller and a host. The controller is configured to actively calculate a connection quality parameter according to packets from the slave device between an interval after the link is established and an LMP_setup_complete message is received. The host is configured to receive the connection quality parameter from the controller, and determine whether to terminate the link according to the connection quality parameter.

The present disclosure further provides a master device configured to establish a link with a slave device in a paging procedure of Bluetooth connection. The master device includes a controller and a host. The controller is configured to transmit an HCI_connection_complete message after receiving an LMP_setup_complete message from the slave device. The host is configured to transmit a quality requiring command to the controller to ask the controller to provide a connection quality parameter after receiving the HCI_connection_complete message from the controller.

The present disclosure further provides a slave device configured to establish a link with a master device in a paging procedure of Bluetooth connection. The slave device includes a controller and a host. The controller is configured to reply an HCI_connection_request message after receiving an LMP_host_connection_req message from the master device. The host is configured to transmit a quality requiring command to the controller to ask the controller to provide a connection quality parameter after receiving the HCI_connection_request from the controller.

### BRIEF DESCRIPTION OF THE DRAWINGS

Other objects, advantages, and novel features of the present disclosure will become more apparent from the following detailed description when taken in conjunction with the accompanying drawings.

FIG. 1 is a LMP message sequence chart of a Bluetooth communication system according to one embodiment of the present disclosure.

FIG. 2 is a LMP message sequence chart of a Bluetooth communication system according to another embodiment of the present disclosure.

### DETAILED DESCRIPTION OF THE EMBODIMENT

It should be noted that, wherever possible, the same reference numbers will be used throughout the drawings to refer to the same or like parts.

One objective of the present disclosure is to provide a Bluetooth communication system whose master device or slave device has the right to terminate a link or connection when the link quality or the connection quality is identified to be poor after a link is established between the master device and the slave device so as to avoid the pairing data to be cleaned and to increase the connection success rate.

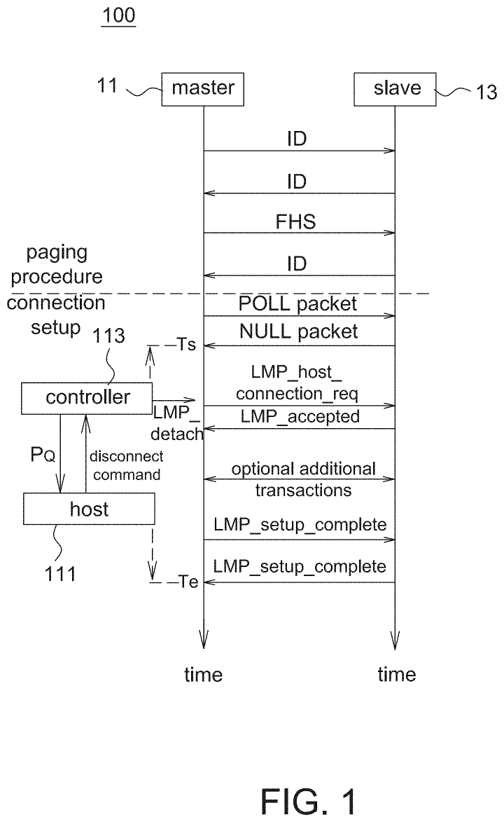

Please refer to FIG. 1, it is an operational schematic diagram of a Bluetooth communication system 100 according to one embodiment of the present disclosure. The Bluetooth communication system 100 includes a master device 11 and a slave device 13 that establish a link therebetween using a paging procedure of Bluetooth connection. The master device 11 includes a host 111 and a controller 113 coupled to each other.

In the present disclosure, the master device 11 and the slave device 13 of the Bluetooth communication system 100 are selected, without particular limitations, from, for example a portable electronic device, a wearable electronic device, a vehicle electronic device, a computer peripheral, a Bluetooth earphone, a Bluetooth speaker or other electronic devices using Bluetooth communication to transmit data.

In the paging procedure, the master device 11 firstly sends a page message to the slave device 13, and then the slave device 13 replies a page response message to the master device 11. After successively receiving the page response message, the master device 11 then transmits an FHS packet to the slave device 13. After successively receiving the FHS packet, the slave device 13 replies another page response message to the master device 11 as an acknowledgement of receiving the FHS packet to accomplish the establishment of a link. In this way; the master device 11 and the slave device 13 enter a connection state, as the connection setup below a dashed line shown in FIG. 1.

The paging procedure is known to the art and not a main objective of the present disclosure, and thus details thereof are not described herein.

In the connection state, the master device 11 transmits a POLL packet to the slave device 13, and the slave device 13 replies a NULL packet to the master device 11 as a first traffic. It is appreciated that the exchanging of the POLL packet and the NULL packet between the master device 11 and the slave device 13 is not limited to one time only.

The definition and function of the FHS packet, the POLL packet and the NULL packet are known to the art and thus details thereof are not described here.

In the embodiment of FIG. 1, the master device 11 determines whether to terminate or cutoff a link or a connection according to the link quality or connection quality at any time after the connection state is entered and before the link management protocol (LMP) setup is complete. For example, in one aspect, the controller 113 of the master device 11 actively calculates a link or connection quality parameter P_{Q} (abbreviated as connection quality parameter hereinafter) according to every packet from the slave device 13 after the link is established (e.g., receiving the NULL packet from the slave device 13 at time Ts, but not limited to) and before receiving an LMP_setup_complete message at time Te from the slave device 13, wherein the connection quality parameter P_{Q} includes at least one of a received signal strength indicator (RSSI) and an error rate (ER), or other parameters capable of indicating the link quality or connection quality without particular limitations.

The controller 113 is embedded with a vendor defined protocol, which is implemented by hardware and/or firmware, for actively using every packet from the slave device 13 to calculate and provide the connection quality parameter P_{Q}. The controller 113 is arranged in the way that when one packet is received, the connection quality parameter P_{Q} is actively calculated and provided, or the controller 113 is arranged to calculate and provide the connection quality parameter P_{Q} every predetermined time interval.

The host 111 of the master device 11 receives the connection quality parameter P_{Q} from the controller 113, and determines whether to terminate or cutoff the link or connection according to the received connection quality parameter P_{Q}. In one aspect, the host 111 compares (e.g., using a processor therein) the connection quality parameter P_{Q} with a quality threshold (e.g., previously stored or recorded in the master device 11). When the connection quality parameter P_{Q} is smaller than the quality threshold, it means that the link quality or connection quality is not good and thus a disconnect command is sent by the host 111 to the controller 113. After receiving the disconnect command, the controller 113 sends a disconnect message (e.g., LMP_detach) to the slave device 13 to terminate or cutoff the link or connection.

When the connection quality parameter P_{Q} is larger than the quality threshold, it means that the link quality or connection quality is good, and thus the connection setup is proceeding.

In the embodiment of FIG. 1, the definition and function of the messages of LMP_setup_complete and LMP_detach are known to the art and thus details thereof are not described herein.

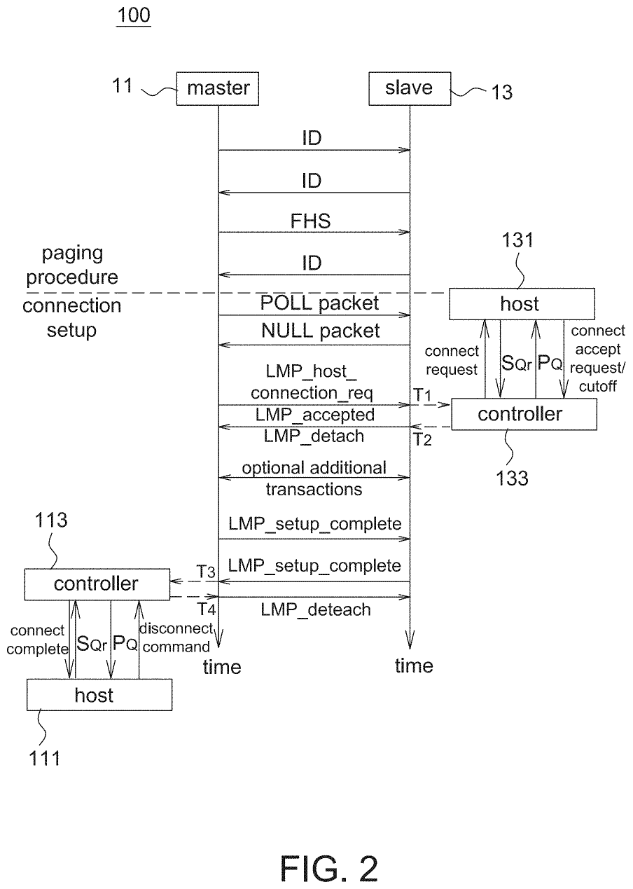

Please refer to FIG. 2, it is an operational schematic diagram of a Bluetooth communication system 100 according to another embodiment of the present disclosure. Similarly, the Bluetooth communication system 100 includes a master device 11 and a slave device 13 for establishing a link therebetween using a paging procedure of Bluetooth connection. The master device 11 includes a host 111 and a controller 113 coupled to each other. The slave device 13 includes a host 131 and a controller 133 coupled to each other.

The method of establishing a link between the master device 11 and the slave device 13 in a paging procedure has been described above, and thus details thereof are not repeated herein. The difference between embodiments of FIG. 2 and FIG. 1 is that in FIG. 2, after entering the connection state, e.g., below the dashed line, the master device 11 determines whether to terminate or cutoff a link or a connection according to a connection quality till receiving an LMP_setup_complete message from the slave device 13.

For example, in one aspect, the controller 113 of the master device 11 transmits a connection complete message (e.g., HCI_connection_complete) after receiving an LMP_setup_complete message at time T₃ from the slave device 13. The host 111 of the master device 11 transmits a quality requiring command S_{Qr} to the controller 113 to ask the controller 113 to provide a connection quality parameter P_{Q} after the host 111 receives the HCI_connection_complete message from the controller 113. In one aspect, the host 111 of the master device 11 is embedded with a vendor defined protocol, which is implemented by hardware and/or software, for transmitting the quality requiring command S_{Qr} after receiving the HCI_connection_complete message. The quality requiring command S_{Qr} is, for example, a digital signal containing a predetermined number of bits.

Similarly, the connection quality parameter P_{Q} includes at least one of the RSSI or ER, or other parameters capable of indicating the link quality or connection quality without particular limitations.

In the embodiment of FIG. 2, the controller 113 is embedded with a vendor defined protocol, which is implemented by hardware and/or firmware, for using every packet from the slave device 13 to calculate and provide the connection quality parameter P_{Q} after the controller 113 receives the quality requiring command S_{Qr}.

The host 111 of the master device 11 receives the connection quality parameter P_{Q} from the controller 113, and then determines whether to terminate or cutoff the link or connection according to the connection quality parameter P_{Q}. In one aspect, the host 111 compares (e.g., using a processor therein) the received connection quality parameter P_{Q} with a quality threshold (e.g., previously stored or recorded in the master device 11). When the connection quality parameter P_{Q} is smaller than the quality threshold, it means that the link or connection quality is not good, and thus a disconnect command is sent by the host 111 to the controller 113. After receiving the disconnect command, the controller 113 sends an LMP_detach message at time T₄ to the slave device 13 to terminate or cutoff the link or connection.

When the connection quality parameter P_{Q} is larger than the quality threshold, it means that the link or connection quality is good, and the connection state is maintained.

In the embodiment of FIG. 2, the link or connection is terminated not only by the master device 11 but also by the slave device 13.

For example, in one aspect, the controller 133 of the slave device 13 transmits a connection request message (e.g., HCI_connection_request) after receiving an LMP_host_connection_req message from the master device 11 at time T₁. After receiving the HCI_connection_request message from the controller 133, the host 131 of the slave device 13 transmits a quality requiring command S_{Q}r to the controller 133 to ask the controller 133 to provide a connection quality parameter P_{Q}. The host 131 is embedded with a vendor defined protocol, which is implemented by hardware and/or firmware, for sending the quality requiring command S_{Qr} in responding to the HCI_connection_request message.

The controller 133 of the slave device 13 is embedded with a vendor defined protocol, which is implemented by hardware and/or firmware, for using every packet from the master device 11 to calculate and provide the connection quality parameter P_{Q} after the controller 133 receives the quality requiring command S_{Qr}, from the host 131.

In another aspect, before receiving the quality requiring command S_{Qr} from the host 131, the controller 133 uses every packet from the master device 11 to calculate and record the connection quality parameter P_{Q}, and the connection quality parameter P_{Q} is provided only after the quality requiring command S_{Qr} is received from the host 131.

Similarly, the connection quality parameter P_{Q} includes at least one of a received signal strength indicator and an error rate, or other parameters capable of indicating the link quality or connection quality without particular limitations.

The host 131 of the slave device 13 is embedded with a vendor defined protocol, which is implemented by hardware and/or firmware, for comparing (e.g., using a processor therein) the received connection quality parameter P_{Q} with a quality threshold (e.g., previously stored or recorded in the slave device 13) to determine whether to terminate or cutoff the link or connection according to the comparing result.

For example, when the connection quality parameter P_{Q} is smaller than the quality threshold, it means that the connection quality is not good, and thus the host 131 transmits a disconnect command (shown as cutoff in FIG. 2) to the controller 133. After receiving the disconnect command, the controller 133 sends an LMP_detach message to the master device 11 at time T₂ after receiving the disconnect command so as to terminate or cutoff the link or connection. On the other hand, when the connection quality parameter P_{Q} is larger than the quality threshold, it means that the connection quality is good and thus the host 131 transmits an accept connection request message (e.g., HCI_accept_connection_request) to the controller 133. After receiving the HCI_accept_connection_request message, the controller 133 transmits an accepted message (e.g., shown as LMP_accepted) at time T₂ to the master device 11.

In the standard Bluetooth protocol, after receiving an HCI_connection_request message, the host 131 directly transmits an HCI_accept_connection_request message to the controller 133. However, the present disclosure arranges a vendor defined protocol in the host 131 such that the host 131 does not directly send the HCI_accept_connection_request message after receiving the HCI_connection_request message but sends the HCI_accept_connection_request message to the controller 133 after confirming the link or connection quality is good.

In the embodiment of FIG. 2, the definition and function of the messages of LMP_setup_completet, LMP_detach, LMP_host_connection_req, HCI_connection_request, HCI_accept_connection_request and LMP_accepted are known to the art and thus details thereof are not described herein.

It should be mentioned that although the present disclosure is described in the way that the controllers 113 and 133 calculate the connection quality parameter P_{Q} using every received packet, the present disclosure is not limited thereto. In other aspects, the controllers 113 and 133 are arranged in the way to calculate the connection quality parameter P_{Q} by using only predetermined packet type(s) instead of calculating the connection quality parameter P_{Q} using every packet, or in the way to calculate the connection quality parameter P_{Q} once every predetermined time interval according to different applications.

In FIG. 2, the optional additional transactions include, for example, pairing, authentication and encryption, but not limited to.

As mentioned above, because the Bluetooth module of conventional electronic devices does not have the function of actively terminating the connection when the connection quality is poor, it is possible that the pairing data is unwillingly cleaned. Therefore, the present disclosure further provides a master device and a slave device of a Bluetooth communication system (referring to FIGS. 1 and 2) that determine whether to disconnect the link according to the link quality or connection quality, wherein a controller of the master device actively or passively provides a connection quality parameter to a host of the master device, and a controller of the slave device passively provides a connection quality parameter to a host of the slave device.

Although the disclosure has been explained in relation to its preferred embodiment, it is not used to limit the disclosure. It is to be understood that many other possible modifications and variations can be made by those skilled in the art without departing from the spirit and scope of the disclosure as hereinafter claimed.

What is claimed is:

1. A master device, configured to establish a link with a slave device in a paging procedure of Bluetooth connection, the master device comprising:
a controller, configured to actively calculate a connection quality parameter according to packets from the slave device between an interval after the link is established and an LMP_setup_complete message is received; and
a host, configured to
receive the connection quality parameter from the controller, and
determine whether to terminate the link according to the connection quality parameter.

2. The master device as claimed in claim 1, wherein the connection quality parameter comprises at least one of a received signal strength indicator and an error rate.

3. The master device as claimed in claim 1, wherein the host is configured to
compare the connection quality parameter with a quality threshold, and
transmit a disconnect command to the controller when the connection quality parameter is smaller than the quality threshold.

4. The master device as claimed in claim 3, wherein the controller is configured to transmit an LMP_detach message to the slave device to terminate the link after receiving the disconnect command.

5. The master device as claimed in claim 1, wherein the controller is embedded with a vendor defined protocol configured to actively use the packets from the slave device to calculate and provide the connection quality parameter.

6. The master device as claimed in claim 1, wherein the controller is configured to actively provide the connection quality parameter to the host after receiving a NULL packet from the slave device.

7. A master device, configured to establish a link with a slave device in a paging procedure of Bluetooth connection, the master device comprising:
a controller, configured to transmit an HCI_connection_complete message after receiving an LMP_setup_complete message from the slave device; and
a host, configured to transmit a quality requiring command to the controller to ask the controller to provide a connection quality parameter after receiving the HCI_connection_complete message from the controller.

8. The master device as claimed in claim 7, wherein the controller is embedded with a vendor defined protocol configured to use packets from the slave device to calculate and provide the connection quality parameter after receiving the quality requiring command.

9. The master device as claimed in claim 7, wherein the connection quality parameter comprises at least one of a received signal strength indicator and an error rate.

10. The master device as claimed in claim 7, wherein the host is configured to
compare the connection quality parameter with a quality threshold, and
transmit a disconnect command to the controller when the connection quality parameter is smaller than the quality threshold.

11. The master device as claimed in claim 10, wherein the controller is configured to transmit an LMP_detach message to the slave device to terminate the link after receiving the disconnect command.

12. The master device as claimed in claim 7, wherein the host is embedded with a vendor defined protocol configured to transmit the quality requiring command after receiving the HCI_connection_complete message.

13. A slave device, configured to establish a link with a master device in a paging procedure of Bluetooth connection, the slave device comprising:
a controller, configured to reply an HCI_connection_request message after receiving an LMP_host_connection_req message from the master device; and
a host, configured to transmit a quality requiring command to the controller to ask the controller to provide a connection quality parameter after receiving the HCI_connection_request from the controller.

14. The slave device as claimed in claim 13, wherein the controller is embedded with a vendor defined protocol configured to use packets from the mater device to calculate and provide the connection quality parameter after receiving the quality requiring command.

15. The slave device as claimed in claim 13, wherein the connection quality parameter comprises at least one of a received signal strength indicator and an error rate.

16. The slave device as claimed in claim 13, wherein the host is configured to
compare the connection quality parameter with a quality threshold, and
transmit a disconnect command to the controller when the connection quality parameter is smaller than the quality threshold.

17. The slave device as claimed in claim 16, wherein the controller is configured to transmit an LMP_detach message to the master device to terminate the link after receiving the disconnect command.

18. The slave device as claimed in claim 13, wherein the host is configured to
compare the connection quality parameter with a quality threshold, and
transmit an HCI_accept_connection_request message to the controller when the connection quality parameter is larger than the quality threshold.

19. The slave device as claimed in claim 18, wherein the controller is configured to transmit an LMP_accepted message to the master device after receiving the HCI_accept_connection_request message.

20. The slave device as claimed in claim 13, wherein the host is embedded with a vendor defined protocol configured to transmit the quality requiring command according to the HCI_connection_request message.
